(19) United States
(12) Patent Application Publication
(10) Pub. No.: US 2013/0279739 A1
(43) Pub. Date: Oct. 24, 2013

(54) Acoustic Transducer Basket Assembly

(71) Applicant: Knowles Electronics Asia PTE. Ltd., Singapore (SG)

(72) Inventors: Herbert Nemeth, Vienna (AT); Michael Schöffmann, Siegenfeld (AT)

(21) Appl. No.: 13/865,882

(22) Filed: Apr. 18, 2013

Related U.S. Application Data
(60) Provisional application No. 61/635,746, filed on Apr. 19, 2012.

(51) Int. Cl. H04R 1/00

(52) U.S. Cl. CPC H04R 1/00
USPC 381/433

(57) ABSTRACT

An acoustic transducer basket for receiving and electrically contacting an acoustic transducer. The basket includes a spring bracket formed as an integral part of the basket. First electrical contact areas are formed on this spring for electrically contacting the basket of the spring force of the spring. The basket has second electrical contact areas for electrically connecting the acoustic transducer, and there is an electrical connection between first electrical contact areas and second electrical contact areas.

### FIELD OF THE INVENTION

The invention relates to an acoustic transducer basket for receiving and electrically contacting an acoustic transducer.

### BACKGROUND OF THE INVENTION

In the course of miniaturization of communication devices, particularly cellular phones, the acoustic transducers assembled in these devices became smaller and smaller. Particularly, the electrical contacting of miniaturized loudspeakers with the device became a great challenge.

German Publication No. DE19737134A1 relates to a card reading unit including an identity card inserted into a receiving space. Electric contacts are arranged within the receiving space, on its floor. They contact with corresponding contacts on the identity card. The card carrier is made of non-galvanized plastic, whereby contact bodies of the electric contacts consist of galvanized plastic, embedded partially in the card carrier and having galvanized free surface areas. A spring element made from an elastic plastic is provided on the inside of the fastener arrangement. This document, however, does not relate to the problem of how to contact the card carrier.

In contrast, the contacting of acoustic transducers is much more complex and is of a different kind. Usually, loudspeakers and other acoustic transducers are accommodated in a basket, enclosing or surrounding the active elements of the loudspeaker, in particular the coil, coil wires, membrane and their mechanical supports. In order to contact the coil of the speaker with a printed circuit board, separate connection elements have been so far been employed. In the prior art, connection elements in the form of extremely small metal springs are known. When assembling the loudspeaker with the basket, the metal springs are inserted into recesses provided in the basket. In the assembled state, a contact area of the metal springs is accessible from outside. The contact areas of the metal spring are pressed against corresponding contacts on the printed circuit board, thus establishing an electrical connection.

The assembling process includes the step of inserting correctly orientated tiny metal springs into the recesses of the basket is extremely complex, time-consuming and very costly. This holds not only for speakers, but also for other miniaturized acoustic transducers.

### SUMMARY OF THE INVENTION

In aspects, the invention relates to the contexts of overcoming the problems of the prior art and of providing baskets for receiving and electrically contacting miniaturized acoustic transducers, such as loudspeakers, the baskets having a reliable contact mechanism with corresponding external contacts, e.g. on a printed circuit board. In contrast to the prior art, the production of such baskets as well as of acoustic transducer-basket assemblies should desirably be cost-effective and time-saving.

The acoustic transducer basket receives and electrically contacts an acoustic transducer. The basket includes: a spring formed as an integral part of the basket; first electrical contact areas formed on the spring for electrically contacting the basket via the spring force of the spring; second electrical contact areas for electrically connecting the acoustic transduce; and, an electrical connection between first electrical contact areas and second electrical contact areas.

Due to the fact that, the spring is an integral part of the basket, the production process of the basket or the acoustic transducer-basket assembly is simplified considerably. The basket including spring is now made from one piece, preferably a molded plastic.

The acoustic transducer may be a speaker, receiver, vibrator, or a multifunctional device having two types of transducers.

In an embodiment, the first electrical contact areas are made from a metal plating, preferably a gold plating, applied to the surface of the basket. This measure ensures a reliable electrical connection of the basket with corresponding external contacts, for example on a printed circuit board. A gold plating is preferred due to the fact that, the contact between the first contact areas and, for example the printed circuit board, has to be of good quality.

In an embodiment, the second electrical contact areas are made from a metal plating, preferably a gold plating, applied to the surface of the basket. The gold plating is preferred because the contact with the acoustic transducer, particularly its coil wires, has to be of good quality. The connection may be established by soldering the coil wires to the second contact areas of the basket.

In an embodiment, the electrical connection between first electrical contact areas and second electrical contact areas is made from a metal plating applied to the surface of the basket. The use of a metallic plating on the plastic basket for all contact areas and connection lines allows a space-saving and reliable solution for contacting the acoustic transducer.

Since the thickness of the plating may be smaller than 100 μm, preferably smaller than 50 μm, most preferably smaller than 20 μm, this embodiment effects a space-saving solution. There are several techniques known in prior art to apply an electrically conducting plating on electrically non-conducting, particularly plastics material. Among them are PC/ABS (Polycarbonate/Acrylonitrile butadiene styrene) technique with two-shot process, the Futuron technology, or the PA (polyamide) technique for preparing the surface of plastic. This procedure is followed by electroplating or surface chemical plating with metals as, for example, copper (Cu), and/or nickel (Ni), and/or gold (Au). The total layer thickness may be, for example, only 15 μm. The metal plating forms a rigid connection with the basket surface.

In an embodiment, the spring is made of two bars extending from opposing walls of the basket. Each bar may carry a first electrical contact area. This allows for an elegant separation of the two contact lines required for connecting, for example, the coil of a speaker.

In an embodiment, the bars are parallel to each other, allowing a space-saving arrangement in which the bars align with the walls of the basket.

In an embodiment, the bars are interconnected by a connection part. This enhances mechanical stability and ensures a reliable electrical contact.

In an embodiment, the spring has the form of a bracket, which runs above wall portions of the basket. The bracket is in alignment with the walls extending below. This allows a mechanically stable solution, and, concurrently, an easy production.

In an embodiment, the first electrical contact areas are formed on the bottom side of the basket and the second electrical contact areas are formed on the top side of the basket. This allows an spatial separation between the mounting base, e.g. a PCB, and the second electrical contact areas provided for the acoustic transducer wires.

In an embodiment, the electrical connection between first electrical contact areas and second electrical contact areas extends on the outer face of the basket. The plating can be easily applied from outside.

In an embodiment, the basket has an acoustic opening, and wherein the electrical connection between first electrical contact areas and second electrical contact areas extends through the acoustic opening. The plating is efficiently protected in this area from mechanical stresses during production, assembly, and operation.

In an embodiment, the basket may be made from molded plastic. Easy and cost-effective production methods, such as injection molding may be employed.

The acoustic transducer assembly may include: an acoustic transducer basket according to the present disclosure, and an acoustic transducer having an electrical contact and being received by the basket, wherein the acoustic transducer is electrically connected to the second electrical contact areas, preferably by soldering.

In an embodiment, the acoustic transducer assembly further includes a printed circuit board, wherein the first electrical contact areas of the basket are pressed against corresponding contact areas on the printed circuit board by the spring force of the spring. The basket is pressed against the PCB either by a clip mechanism integrated on the PCB and the basket, or by an “external” force, such as two outer shells of an cellular phone, which are clipped together and clamp the acoustic transducer-basket assembly together with the PCB.

The invention also relates to the context of a communication device, particularly a cellular phone including an acoustic transducer assembly as described above.

### BRIEF DESCRIPTION OF THE DRAWINGS

Further embodiments of the invention are indicated in the figures and in the dependent claims. The invention will now be explained in detail by the drawings. In the drawings:

FIG. 1 depicts a basket according to the invention.

FIG. 2 depicts in top view the basket of FIG. 1.

FIG. 3 depicts in side view the basket of FIG. 2.

FIG. 4 depicts in another side view the basket of FIG. 2.

FIG. 5 depicts an embodiment of the invention.

FIG. 6 schematically depicts a cellular phone.

### DETAILED DESCRIPTION OF THE INVENTION

In regard to the previous summary and as used in following, the phrases “in a/one embodiment,” “according to a/one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment. If the specification states a component or feature “may”, “can”, “could”, or “might” be included or have a characteristic, that particular component or feature is not necessarily required to be included or have the characteristic. Furthermore, as used throughout this specification, the terms “a”, “an”, “at least” do not denote a limitation of quantity, but rather denote the presence of at least one of the referenced item, and the term “a plurality” denotes the presence of more than one referenced items.

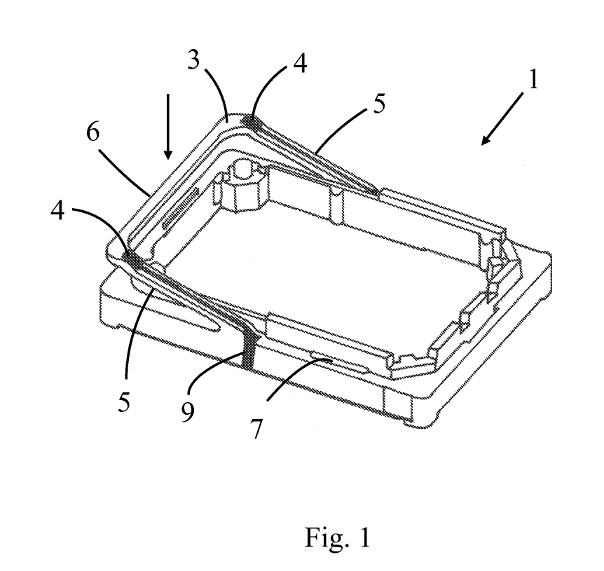

FIG. 1 is a view on the bottom part of a basket 1 for receiving an acoustic transducer 2, which in the present embodiment is a loudspeaker. The basket 1 has rectangular shape and is formed with four walls. A spring 3 is integrally formed with the basket and extends from the walls. The basket 1 including spring 3 is made from one piece. In the present embodiment spring 3 is a bracket formed from two parallel bars 5 and a connecting part 6. When the bottom side of the basket 1 is mounted on a base, such as a printed circuit board (PCB), the spring 3 is pressed against the basket walls (indicated by the vertical arrow in FIG. 1). In this embodiment, the spring force of the spring 3 is, from the basket's point of view (and in the assembled state), an outwardly-directed force.

First electrical contact areas 4 (in FIG. 1 black areas) are provided on the spring 3 for contacting the basket 1 with corresponding external contacts, that are provided on a mounting base, such as a PCB. The first contact areas 4 are formed by an electrically conducting plating applied to the surface of the basket 1. The same holds for the electrical connection 9 connecting the first contact areas 4 with second contact areas 8 on the top side of the basket 1 (not seen in FIG. 1). The electrical connection line 9 (black line) runs on the outer face of the basket.

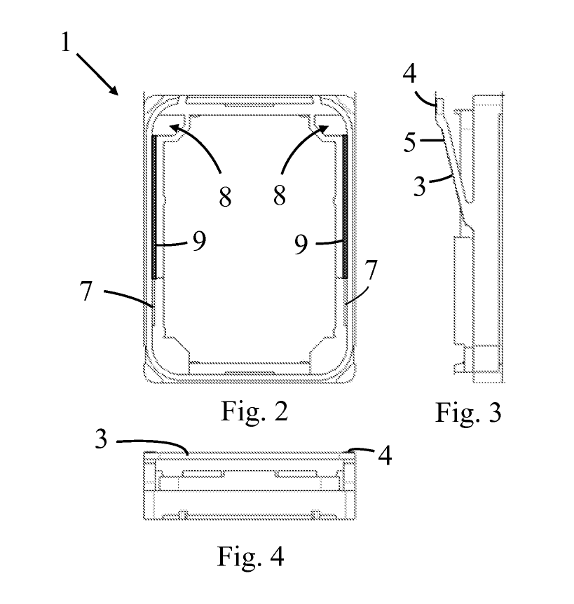

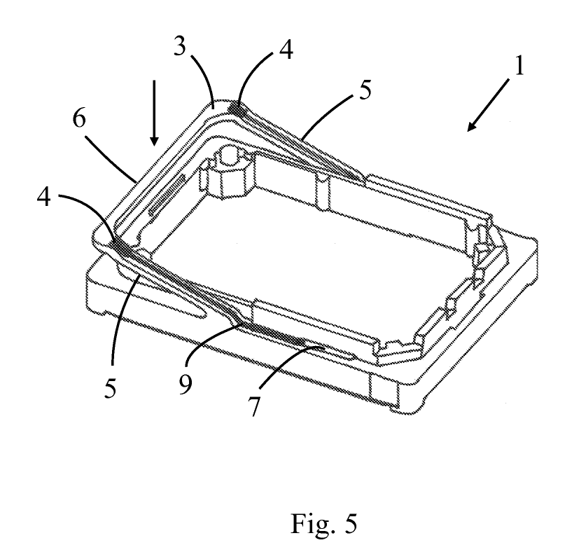

FIGS. 2 to 4 depict the basket in different views. FIG. 2 depicts the top of the basket 1 with second contact areas 8 for electrically connecting with the acoustic transducer (with the wires of the coil). FIG. 3 depicts that the spring bracket 3 is slightly inclined with respect to the edges of the walls. In the assembled state, however, the spring bracket 3 will be essentially parallel to the edges of the walls. FIG. 4 depicts another side view.

FIG. 5 depicts an alternate embodiment with the basket 1 including acoustic openings 7 to additionally guide the sound waves produced by the acoustic transducer 2. In this embodiment the electrical connection line 9 extends through the acoustic opening 7. This allows for a better protection of the connection line 9 from mechanical stress arising during production, assembly, and operation of the basket-acoustic transducer assembly.

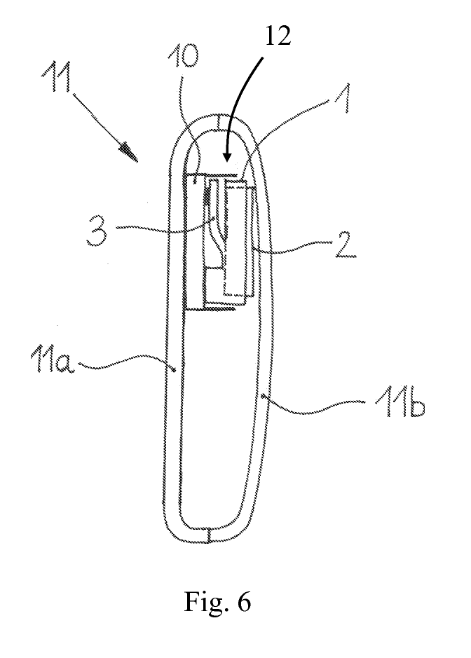

FIG. 6 depicts a communication device in form of a cellular phone 11 enclosed by two shells 11a, 11b, that are connected with each other, preferably by a releasable clip mechanism. The cellular phone 11 includes an acoustic transducer-basket assembly 12 with an acoustic transducer 2 in form of a loudspeaker and with a printed circuit board 10. The acoustic transducer (partially indicated in FIG. 6) is inserted into the basket 1. The basket 1 in turn is forced towards the printed circuit board 10, causing the spring bracket 3 to press with its first electrical contact areas 4 against corresponding contacts on the printed circuit board 10. The mechanism forcing the basket 1 towards the printed circuit board 10 may either be a clip mechanism between basket 1 and printed circuit board 10, or the space between the shells 11a and 11b may be dimensioned such, that the basket 1 and the PCB are forced together, when the shells 11a, 11b are tightly connected with each other.

The invention is not limited to the exemplary embodiments depicted. For example, the design of the basket may be chosen as of different kind (circular, rectangular, etc.). The course of the connection line 9 on the surface of the basket 1 may be of any other kind. The plating processes and the metals employed are not merely limited to the exemplary explicitly described embodiments, but instead should be understood in a wider context. The electrical contact areas 4, 8 may be differently located. Likewise, the dimensions of the basket are correspondingly adapted to the dimensions of the acoustic transducers used. As an example, and in a preferred embodiment for use in cellular phones, the length of the basket is smaller than 30 mm, more preferably smaller than 20 mm, and most preferably smaller than or equal to 15 mm.

In closing, it should be noted that the invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

What is claimed is:

1. An acoustic transducer basket assembly comprising:
an acoustic transducer;
a basket body configured to receive the acoustic transducer;
a spring integrally formed as part of the basket body;
a plurality of first electrical contact areas formed on the spring, the plurality of first electrical contact areas configured to electrically connect the basket body to a mounting surface;
a plurality of second electrical contact areas formed on the basket body, the plurality of second electrical contact areas configured to electrically connect the acoustic transducer and the basket body; and
respective electrical connectors located on the basket body, the electrical connectors arranged to electrically connect the respective first electrical contact areas and the respective second electrical contact areas.

2. The acoustic transducer basket assembly of claim 1, wherein the plurality of first electrical contact areas are made from a metal plating applied to a surface of the spring.

3. The acoustic transducer basket assembly of claim 2, wherein the metal plating is gold plating.

4. The acoustic transducer basket assembly of claim 1, wherein the plurality of second electrical contact areas are made from a metal plating applied to a surface of the basket body.

5. The acoustic transducer basket assembly of claim 4, wherein the metal plating is gold plating.

6. The acoustic transducer basket assembly of claim 1, wherein at least one of the respective electrical connectors is made from a metal plating applied to a surface of the basket body.

7. The acoustic transducer basket assembly of claim 1, wherein:
the basket body comprises a first wall and a second wall, the second wall being opposite the first wall; and
the spring comprises a first bar extending from the first wall and a second bar extending from the second wall.

8. The acoustic transducer basket assembly of claim 7, wherein the first bar is parallel to the second bar.

9. The acoustic transducer basket assembly of claim 7, wherein the spring further comprises a connection segment connecting the first bar to the second bar.

10. The acoustic transducer basket assembly of claim 1, wherein:
the basket body comprises a plurality of wall portions; and
the spring is in the form of a bracket, the spring bracket form running above the wall portions of the basket body.

11. The acoustic transducer basket assembly of claim 1, wherein the basket body further comprises a bottom side and a top side, wherein:
the plurality of first electrical contact areas formed on the spring are arranged on the bottom side of the basket body; and
the plurality of second electrical contact areas are formed on the top side of the basket body.

12. The acoustic transducer basket assembly of claim 1, wherein the basket body comprises an outer face and the respective electrical connectors extend on the outer face of the basket body.

13. The acoustic transducer basket assembly of claim 1, wherein the basket body comprises an acoustic opening and the respective electrical connectors extend through the acoustic opening.

14. The acoustic transducer basket assembly as claimed in claim 1, wherein the basket body is made from molded plastic.

15. The acoustic transducer basket assembly of claim 1, wherein the acoustic transducer has at least one electrical contact, the at least one electrical contact of the acoustic transducer being electrically connected to at least one of the plurality of second electrical contact areas.

16. The acoustic transducer basket assembly of claim 15, wherein the at least one electrical contact of the acoustic transducer is electrically connected to at least one of the plurality of second electrical contact areas by soldering.

17. The acoustic transducer basket assembly of claim 15, further comprising a printed circuit board, the printed circuit board having a plurality of circuit board contact areas corresponding to the plurality of first electrical contact areas of the spring, wherein the plurality of first electrical contact areas are pressed in assembly against respective corresponding ones of the plurality of circuit board contact areas by the spring's exerted spring force.

18. The acoustic transducer basket assembly as claimed in claim 1, wherein the basket body is configured to be incorporated into a cellular phone.

19. An acoustic transducer basket comprising:
a basket body configured to receive an acoustic transducer;
a spring integrally formed as part of the basket body;
a plurality of first electrical contact areas formed on the spring, the plurality of first electrical contact areas configured to electrically connect the basket body to a mounting surface;
a plurality of second electrical contact areas formed on the basket body, the plurality of second electrical contact areas configured to electrically connect the basket body to an acoustic transducer received by the basket body; and
respective electrical connectors located on the basket body, the electrical connectors arranged to electrically connect the respective first electrical contact areas and the respective second electrical contact areas.

20. The acoustic transducer basket of claim 19, wherein:
the basket body comprises a first wall and a second wall opposite the first wall; and
the spring comprises a first bar extending from the first wall and a second bar extending from the second wall.

21. The acoustic transducer basket of claim 19, wherein the basket body has wall portions, wherein the spring has a bracket form, the spring bracket form running above the wall portions of the basket body.
